(19) United States
(12) Patent Application Publication
(10) Pub. No.: US 2009/0218000 A1
(43) Pub. Date: Sep. 3, 2009

(54) Apparatus for Redirecting a Medium Flowing in a Pipeline

(75) Inventor: Axel Pfau, Arleshein (CH)

Correspondence Address: BACON & THOMAS, PLLC, 625 SLATERS LANE, FOURTH FLOOR, ALEXANDRIA, VA, 22314-1176, US

(73) Assignee: ENDRESS + HAUSER FLOWTEC AG, Reinach (CH)

(21) Appl. No.: 12/087,484

(22) PCT Filed: Jan. 8, 2007
(86) PCT No.: PCT/EP2007/050149

§ 371 Date: Jan. 14, 2009

(30) Foreign Application Priority Data
Jan. 10, 2006 (DE) 10 2006 001 417.0

(51) Int. Cl. F15D 1/04; F16L 43/00; F16L 55/027

(52) U.S. Cl. 138/39; 138/37; 138/40; 138/44

(57) ABSTRACT

An apparatus for redirecting a medium flowing in a pipeline. The apparatus includes a plurality of individual tubes and at least a first perforated plate and a second perforated plate having a plurality of perforations, wherein the first perforated plate is provided in the region of the inlet and wherein the second perforated plate is provided in the region of the outlet for the purpose of holding and guiding the individual tubes. The number of perforations in the two perforated plates corresponds to the number of individual tubes, wherein the individual tubes each bend in a central region by a predetermined bending angle, wherein the bending angle of each individual tube is so selected, that the individual tubes form a bundle having an essentially circular cross section. The individual tubes extend in the bundle essentially parallel to one another, and wherein the inlet region and the outlet region of each individual tube are straight.

The invention relates to an apparatus for redirecting a medium flowing in a pipeline.

In many technical applications, it is necessary to guide a developed, rotationally symmetric, flow profile, free of swirl, via a curved pipeline. By way of example, consider a calibration plant for a flow measuring device. In such case, 90° elbows are usual and necessary, geometric units for changing the flow direction of the medium in the workspace. Important for highly accurate and reproducible calibration of a flow measuring device (the discussion below being true, especially, for magneto-inductive measuring devices, but also for other principles of flow measurement resting on the registering of the velocity profile, e.g. such as the ultrasonic and thermal principles of measurement or resting especially sensitively on changes in the velocity profile, e.g. the vortex principle) is that the medium flowing in the pipeline exhibit, to a high degree, a steady-state, rotationally symmetric, swirl-free, flow profile. Thus, in order that a highly accurate calibration can be done, it must be made certain that the medium has, over a defined intake distance in front of the flow measuring device to be calibrated, this stable, rotationally symmetric, swirl-free, flow profile. The defined intake distance is, for example, a whole-numbered multiple of the diameter of the pipeline. In the case of large nominal diameters of more than a meter (such a diameter being, in the case of magneto-inductive flow measuring devices and in the case of ultrasonic flow measuring devices, no rarity), the intake distance then can amount to a number of meters. In order to install a calibration plant for flow measuring devices of large nominal diameter, a correspondingly large space must, therefore, be available.

From the point of view of minimizing pressure-loss in redirecting a medium in a pipeline, many forms of 90° elbows have become known. Examples include curved pipe elbows, elbows with guide vanes, elbows constructed of pipe segments, or numerically-optimized, elbow shapes. In the case of the last named example, the method of inverse design with the help of computer calculations is used.

In the case of calibration plants for calibrating flow measuring devices, the above-cited elbows are only conditionally applicable, and this for a number of reasons:
The cited elbows produce disturbances in the flow and these disturbances can be very stable, such that they do not decay from their site of origination until past the position of the flow measuring device, i.e. they do not blend out. Possible disturbances include, in the field discussed here, especially the development of secondary vortices, swirling, non-uniform mass distribution (e.g. stratifications, strands) and non-stationary effects. Various forms of straighteners, or conditioners, have become known for eliminating disturbances/effects in the flow. Thus, straightening can be accomplished by enforced parallel guiding of flow lines with the aid of tube bundles, Zanker straighteners, or honeycomb straighteners. Furthermore, blending out can be made to happen by effecting a pressure-loss in the pipeline. The pressure-loss in the pipeline can be produced by perforated plates, grates or VORTAB flow conditioners.
In order, for example, to design a calibration plant using the method of inverse design, relatively high investment costs are needed.
Additionally, calibration plants, in which the above-referenced, known pipe elbows are installed, require a lot of space.

An object of the invention is to provide an apparatus which enables redirecting a medium flowing in a pipeline with an essentially steady-state flow profile, while maintaining its mass flow distribution and removing a possibly present swirl in the manner of a tube bundle straightener in the flow. Preferably, the flow profile, in the use of the apparatus of the invention in a calibration plant for flow measuring devices, is developed such that it is steady-state, rotationally symmetric, swirl-free, and fully developed over a defined intake distance.

The object is achieved by the pipe elbow of the invention, including the following sub components:
A plurality of individual tubes and at least a first perforated plate and a second perforated plate, each with perforations, wherein the number of perforations in the two perforated plates corresponds to the number of individual tubes.
The first perforated plate is provided in the region of the inlet and the second perforated plate in the region of the outlet for the purpose of holding and guiding the individual tubes.
The individual tubes bend in a central region, in each case, with a predetermined bend angle, wherein the bend angle of each individual tube is so selected that the individual tubes form a bundle having an essentially circular cross section.
The individual tubes extend in the bundle essentially parallel to one another.
The region of the inlet and the region of the outlet of each individual tube are straight.

According to the invention, the total mass flow in the pipeline is divided among the individual tubes of the pipe elbow and then redirected. By the solution of the invention, the development of secondary flows in the individual tubes is very strongly diminished, since the formation of secondary flows is, to a first approximation, inversely proportional to the relative curvature of the individual tubes. The pressure loss of the individual tubes depends, thus, less on the curvature then on the length of the individual tubes. As a result, the mass flow distribution developed at the inlet is redirected, quasi unchanged by the pipe elbow of the invention, into another flow plane. If the flow profile at the inlet of the pipe elbow is developed steady-state, fully, swirl-free and rotation symmetrically, then the flow profile exhibits these characteristics also at the outlet of the pipe elbow. An existing swirl is removed by the solution of the invention.

In an advantageous further development of the apparatus of the invention, the individual tubes, respectively the perforations in the two perforated plates, are arranged in concentric, annular layers. For example, a pipe elbow having a nominal diameter of 1200 mm contains 63 individual tubes. The individual tubes all have the same inner diameter d. One individual tube is arranged centrally on the central axis of the pipe elbow, and the remaining individual tubes are placed in annular layers around the central individual tube. Preferably, the individual tubes and the perforated plates are made of metal or plastic.

An embodiment, which is viewed as especially advantageous, is that wherein the apparatus of the invention is part of a calibration plant or some other application where the form of the flow profile has special importance. Preferably, the elbow is placed before a flow measuring device which is to be calibrated.

In an advantageous form of embodiment, additionally, a straightener plate is provided, which is positioned after the region of the outlet; the straightener plate has a plurality of perforations, with the number of perforations in the straightener plate being greater than the number of perforations in one of the two perforated plates. By the distribution of perforations in the straightener plate, the two secondary vortices, which arise in each individual tube, are purposefully mixed and destroyed. Preferably, the straightener plate is positioned downstream at a defined distance from the second perforated plate at the outlet of the pipe elbow. Preferably, the defined distance is about half as large as the nominal diameter of the pipeline.

The invention will now be explained in greater detail on the basis of the drawing, the figures of which show as follows:

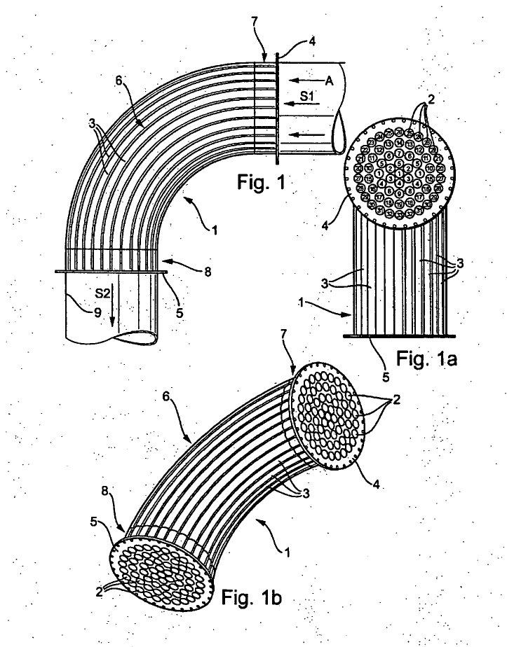

FIG. 1 a side view of a preferred embodiment of the pipe elbow of the invention;

FIG. 1a a plan view onto the pipe elbow according to the cutting plane A-A of FIG. 1;

FIG. 1b a perspective view of the pipe elbow; and

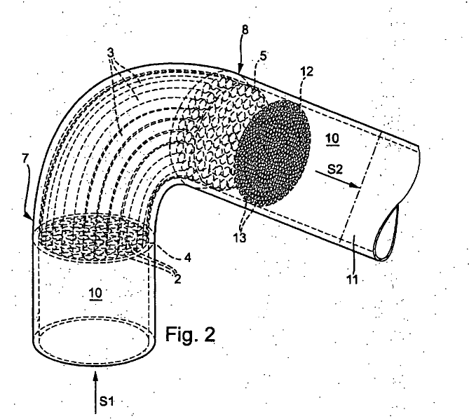

FIG. 2 a pipe elbow of the invention installed in a calibration plant for flow measuring devices.

FIGS. 1, 1a and 1b show different views of a preferred embodiment of the pipe elbow 1 of the invention. The pipe elbow 1 of the invention is composed of a plurality of individual tubes 3 and at least a first perforated plate 4 at the inlet of the pipe elbow 1 and a second perforated plate 5 at the outlet of the pipe elbow 1. Both perforated plates 4, 5 have a plurality of perforations 2, with the number of perforations 2 in the two perforated plates 4, 5 corresponding to the number of individual tubes 3. Preferably the individual tubes 3 and the perforated plates 4, 5 are made of metal, for example stainless steel, or of plastic.

The first perforated plate 4 at the inlet and the second perforated plate 5 at the outlet of the pipe elbow 1 serve for holding and guiding the individual tubes 3. The individual tubes 3 bend in a central region 6, in each case, with a predetermined bending angle a, with the bending angle a of each individual tube 3 being so selected that the individual tubes 3 form a bundle of essentially circular cross section. In the illustrated case, the bending angle is equal to 90°. In the bundle, the individual tubes 3 extend essentially parallel to one another.

In the illustrated case, pipe elbow 1 contains 63 individual tubes 3, with the individual tubes 3 all having an identical inner diameter d. The individual tubes 3 are arranged on concentric circles. One individual tube 3 is placed centrally, and the other individual tubes 3 are arranged around this centrally positioned, individual tube 3 in four plies. The particular, relative curvature of an individual tube 3 depends on its radius of curvature r and the inner diameter d. If the ratio R/D of radius of curvature R of the pipeline 11 to the diameter D of the pipeline 11, or pipe elbow 1, equals 1.5, then the individual tubes 3 have a relative curvature r between 11 and 21. The region 7 of the inlet and the region 8 of the outlet of each individual tube 3 are straight and are a multiple of the inner diameter d long.

As already stated, the idea and purpose of the pipe elbow 1 is to redirect a completely developed, rotationally symmetric, swirl-free flow profile, for example by 90° and, while doing that, retain its mass distribution. To this end, the total mass flow in the pipeline 9 is divided up among the individual tubes 3 of the pipe elbow 1 and then redirected. By the solution of the invention, development of secondary flows in the individual tubes 3 is very strongly diminished, since the development of secondary flows is about inversely proportional to the relative curvature r/d. The pressure loss in the individual tubes 3 depends, thus, less on the curvature r/d than on the length of the individual tubes 3. As a result thereof, the flow profile developed at the inlet is redirected into another flow plane, quasi unchanged, via the pipe elbow 1. If the flow profile FP is steady-state at the inlet of the pipe elbow 1, fully developed and rotationally symmetric, then the flow profile FP exhibits these characteristics, at least approximately, also at the outlet of the pipe elbow 1.

In FIG. 2, the pipe elbow 1 of the invention is installed in a calibration plant for flow measuring devices 11. Between the pipe elbow 1 and the flow measuring device 11 to be calibrated is a straightener plate 12. The straightener plate 12 has a plurality of perforations 13, with the number of perforations 13 in the straightener plate 12 being greater than the number of perforations 2 in the two perforated plates 4, 5. By the distribution of the perforations 13 in the straightener plate 12, the two secondary vortices arising in each individual tube 3 are purposefully mixed and destroyed. Preferably, the straightener plate 12 is positioned spaced from the second perforated plate 5 at the outlet of the pipe elbow 1, e.g. downstream a distance which is approximately half as large as the nominal diameter D of the pipeline 9.

### LIST OF REFERENCE CHARACTERS

1 pipe elbow
2 perforations
3 individual tubes
4 first perforated plate
5 second perforated plate
6 central region
7 inlet region
8 outlet region
9 pipeline
10 medium
11 flow measuring device
12 straightener plate
13 perforations

1-5. (canceled)

6. An apparatus for redirecting a medium flowing in a pipeline, comprising:
a plurality of individual tubes; and at least a first perforated plate and a second perforated plate each having a plurality of perforations, wherein:
said first perforated plate is provided in an inlet region and said second perforated plate is provided in an outlet region for holding and guiding said individual tubes;
said individual tubes and said perforations in said two perforated plates correspond in number;
said individual tubes bend in a central region, in each case, with a predetermined bending angle;
said bending angle of each individual tube is so selected, that said individual tubes form a bundle of essentially circular cross section,
said individual tubes extend in the bundle essentially parallel to one another; and
the inlet region and outlet region of each individual tube are straight.

7. The apparatus as claimed in claim 6, wherein:
said individual tubes, or said perforations in said perforated plates, are arranged in concentric, annular layers.

8. The apparatus as claimed in claim 6, wherein:
said individual tubes and said perforated plates comprise metal or plastic.

9. The apparatus as claimed in claim 6, wherein:
the apparatus is part of a calibration plant and is placed before a flow measuring device to be calibrated.

10. The apparatus as claimed in claim 6, wherein:
a straightener plate is provided positioned downstream from the outlet region;
the straightener plate has a plurality of perforations; and
the number of perforations in the straightener plate is greater than the number of perforations in one of said two perforated plates.
